(19) United States
(12) Patent Application Publication
(10) Pub. No.: US 2006/0162487 A1
(43) Pub. Date: Jul. 27, 2006

(54) Composite shifter cam for a motorcycle transmission

(75) Inventors: Eric M. Chappelear, Milwaukee, WI (US); William J. Hacker, Lisbon, WI (US)

Correspondence Address: MICHAEL BEST & FRIEDRICH, LLP, 100 E WISCONSIN AVENUE, MILWAUKEE, WI, 53202, US

(73) Assignee: Harley-Davidson Motor Company Group, Inc., Milwaukee, WI (US)

(21) Appl. No.: 11/042,369

(22) Filed: Jan. 25, 2005

(51) Int. Cl. F16H 53/00

(52) U.S. Cl. 74/567

(57) ABSTRACT

A composite shifter cam for a sequential transmission includes portions formed of a wear resistant material and portions formed of a lightweight material. The composite structure of the shifter cam allows the heavier, wear resistant material to be used only where it is required, resulting in a lightweight yet durable shifter cam.

### FIELD OF THE INVENTION

The invention relates to shifter cams for sequential transmissions.

### BACKGROUND OF THE INVENTION

Sequential transmissions, such as those utilized in motorcycle transmissions include an input shaft supporting a plurality of input gears, and an output shaft supporting a plurality of output gears. At least some of the gears supported by the input or output shafts are axially moveable along the shafts. Axial movement of the gears engages different combinations of input and output gears with the shafts and with one another to provide different ratios of rotation between the input and output shafts.

Sequential transmissions also include a rotatable shifter cam or shifter drum that defines a plurality of shift tracks. Shifter forks ride in the shift tracks and engage the input and output gears. Rotational movement of the shifter cam (e.g. via a foot-operated shift lever) axially moves the shifter forks, thereby sliding the input and output gears axially along the input and output shafts in a predetermined manner to change the overall gear ratio of the transmission.

To provide accurate, smooth, and reliable shifting, it is desirable to minimize the effort required to rotate the shifter cam and to axially move the shift forks, the input gears, and the output gears. To maintain the quality of shifting over the life of the transmission, it is also desirable to maximize the durability of the components, such as the shift tracks and the shifter forks, which are subject to significant sliding or frictional wear.

### SUMMARY OF THE INVENTION

The present invention provides a shifter cam for a transmission. The shifter cam includes a generally cylindrical drum having a first end and a second end. An outer surface of the shifter cam defines a plurality of shifter tracks. The shifter cam also includes an end cap that is coupled to the first end of the drum. The end cap includes a generally cylindrical portion that is substantially axially aligned with the axis. The drum is comprised of a first material, and the end cap is comprised of a second material that has a lower density than the first material. The shifter cam further includes a plurality of shift pins that extend substantially parallel to the axis. The shift pins are at least partially supported by the end cap and are engageable by a shifter pawl to rotate the end cap and drum to change the gear ratio of the transmission.

The present invention also provides a method for making a composite shifter cam for a transmission. The method includes providing first and second drum portions, each drum portion made from a first material and having a first end and a second end. A sleeve portion is also provided, the sleeve portion made from a second material that has increased hardness with respect to the first material. The sleeve portion is positioned to overlie an outer surface of the first end of the first drum portion, and the first end of the second drum portion is coupled to the first end of the first drum portion. The assembled first and second drum portions and the sleeve portion together define a drum assembly. After the drum assembly has been formed, shifter tracks are machined into the drum assembly such that at least one of the shifter tracks is defined by the sleeve portion.

Various features and advantages of the invention will become apparent to those skilled in the art upon review of the following detailed description, claims, and drawings.

### BRIEF DESCRIPTION OF THE DRAWINGS

FIG. 1 is a perspective view of a shifter cam embodying the present invention.

FIG. 2 is a section view taken along line 2-2 of FIG. 1.

FIG. 3 is an exploded perspective view of another shifter cam embodying the present invention.

FIG. 4 is a section view taken along line 4-4 of FIG. 3.

FIG. 5 is a perspective view of yet another shifter cam embodying the present invention.

FIG. 6 is a section view taken along line 6-6 of FIG. 5.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting.

### DETAILED DESCRIPTION

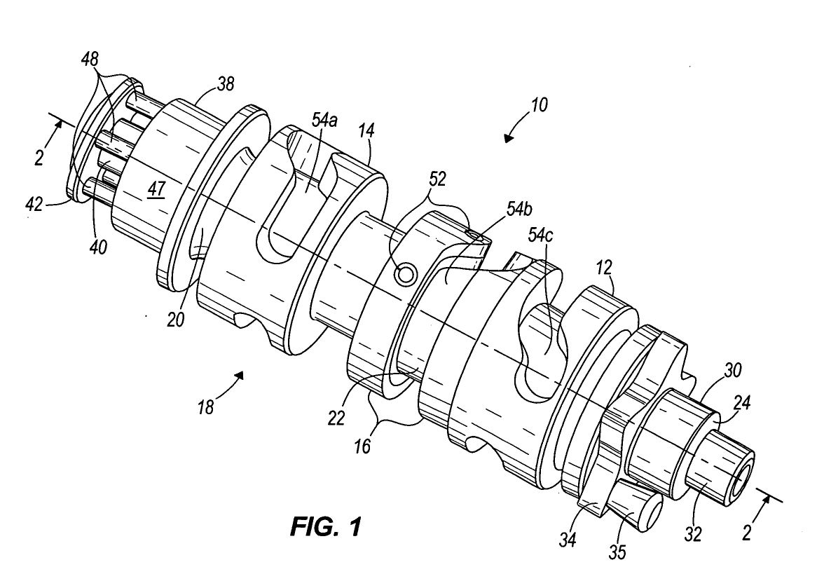

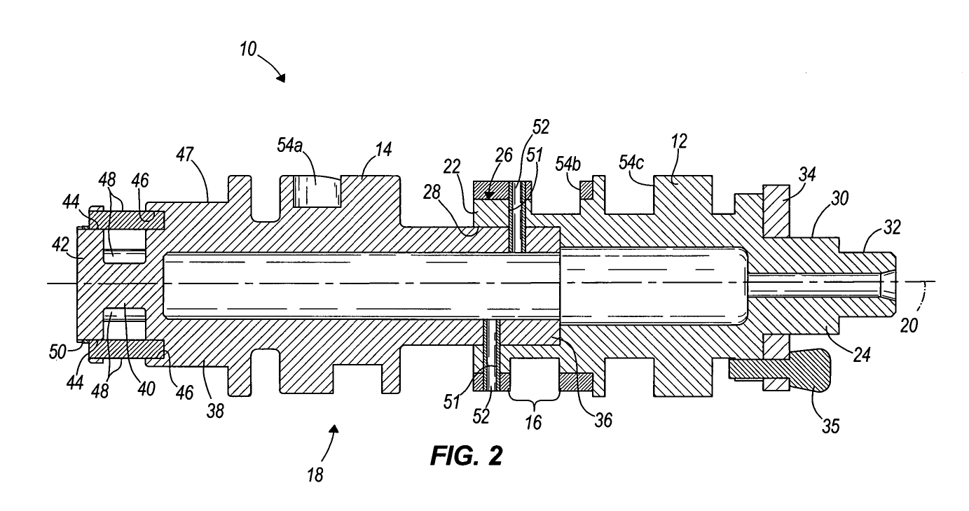

FIGS. 1 and 2 illustrate a shifter cam 10 embodying the invention. The shifter cam 10 includes a first drum portion 12, a second drum portion 14 coupled to the first drum portion 12, and a sleeve portion 16 coupled to the first drum portion 12. The first and second drum portions 12, 14, along with the sleeve portion 16 cooperate to define a drum assembly 18 having a central axis 20. The first drum portion 12 is comprised of a first material and includes a first end 22 and a second end 24. The first end 22 includes a generally cylindrical outer surface 26 and defines an axially extending bore 28. The second end 24 defines a first cylindrical protrusion 30, and a second, reduced diameter cylindrical protrusion 32 that is received by a support member (not shown) such as a bushing or bearing for rotational support of the second end 24 of the first drum portion 12. A detent plate 34 (described further below) is coupled to the first cylindrical protrusion 30 and provides indexing of the shifter cam 10 between predetermined angular positions that correspond with specific transmission ratios. A peg 35 extends through the detent plate 34 and into the first end 22 of the first drum portion 12 and affords proper angular alignment of the detent plate 34 with the first drum portion 12.

The illustrated second drum portion 14 is comprised of the first material and includes a generally cylindrical first end 36 that is press-fit into the bore 28 defined by the first end 22 of the first drum portion 12. A second end 38 of the second drum portion 14 includes a reduced-diameter portion 40 and a flange portion 42. A plurality of angularly spaced apart, axially extending bores 44 are defined in the flange portion 42. The bores 44 are arranged in a bore-circle about the circumference of the flange portion 42. A corresponding group of blind bores 46 are defined in the second end 38 on an opposite side of the reduced-diameter portion 40. The blind bores 46 open toward the flange portion 42 and are substantially axially aligned with the bores 44 in the flange portion 42. The second end 38 also defines a generally cylindrical outer surface 47 that is received by a support member (not shown) such as a bushing or bearing for rotational support of the second end 38 of the second drum portion 14.

The flange portion 42, the bores 44, and the blind bores 46 cooperate to support a plurality of shift pins 48. The shift pins 48 are inserted through the bores 44 and into the blind bores 46. A retaining ring 50 is received by a circumferential groove defined in the flange portion 42 and at least partially overlies the bores 44 to hold the shift pins 48 in place. The shift pins 48 are engaged by a shifter pawl (not shown) during operation of the transmission to rotate the shifter cam 10.

The sleeve portion 16 is comprised of a second material having an increased hardness and improved wear characteristics relative to the first material. The sleeve portion 16 is generally annular and in some constructions is press-fit over the first end 22 of the first drum portion 12. In the illustrated construction, the second material is pre-hardened steel.

Assembly of the shifter cam 10 includes first coupling the sleeve portion 16 to the first end 22 of the first drum portion 12. The first end 36 of the second drum portion 14 is then coupled to the first end 22 of the first drum portion 12. In the illustrated construction, the sleeve portion 16, the first drum portion 12, and the second drum portion 14 are coupled to each other by press-fitting operations. It should be appreciated however that other coupling methods such as threaded engagements, welding, adhesive application, and the like could also be utilized. In the illustrated construction, machining operations are performed on the assembled shifter cam 10 to define bores 51 that extend through the sleeve portion 16, the first drum portion 12, and the second drum portion 14. The bores 51 receive roll pins 52 that prevent relative rotational movement between the sleeve portion 16, the first drum portion 12, and the second drum portion 14.

After the first and second drum portions 12, 14 and the sleeve portion 16 have been coupled to one another, machining operations are performed on the shifter cam 10 to define a plurality of shift tracks 54. In the illustrated construction, there are three shift tracks 54a, 54b, 54c, but the specific number of shift tracks 54 can vary depending upon the configuration of the transmission. In the illustrated construction, the sleeve portion 16 defines the shift track 54b. Because the sleeve portion 16 is constructed of the second material, the shift track 54b has improved wear characteristics relative to the shift tracks 54a, 54c. It should be appreciated that similar construction methods can be utilized to enhance the wear characteristics of different ones, some, or all of the shift tracks 54a, 54b, 54c. The specific configuration of the shifter cam 10 and the associated transmission for which the shifter cam 10 is constructed is such that wear resulting from transmission operation is greatest in the center shift track 54b. For this reason, the hardened steel sleeve 16 is provided to enhance the wear resistance of the shift track 54b. If testing or other analytical methods reveals that a different shift track will experience significantly more wear for a given application, methods of construction and assembly similar to those discussed above can be utilized to improve the wear characteristics of that shift track, as required.

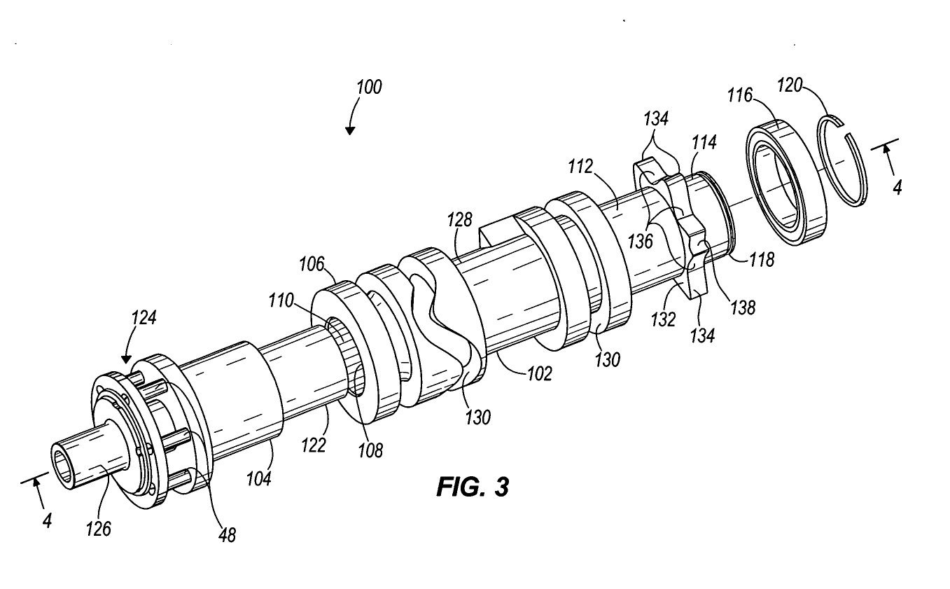

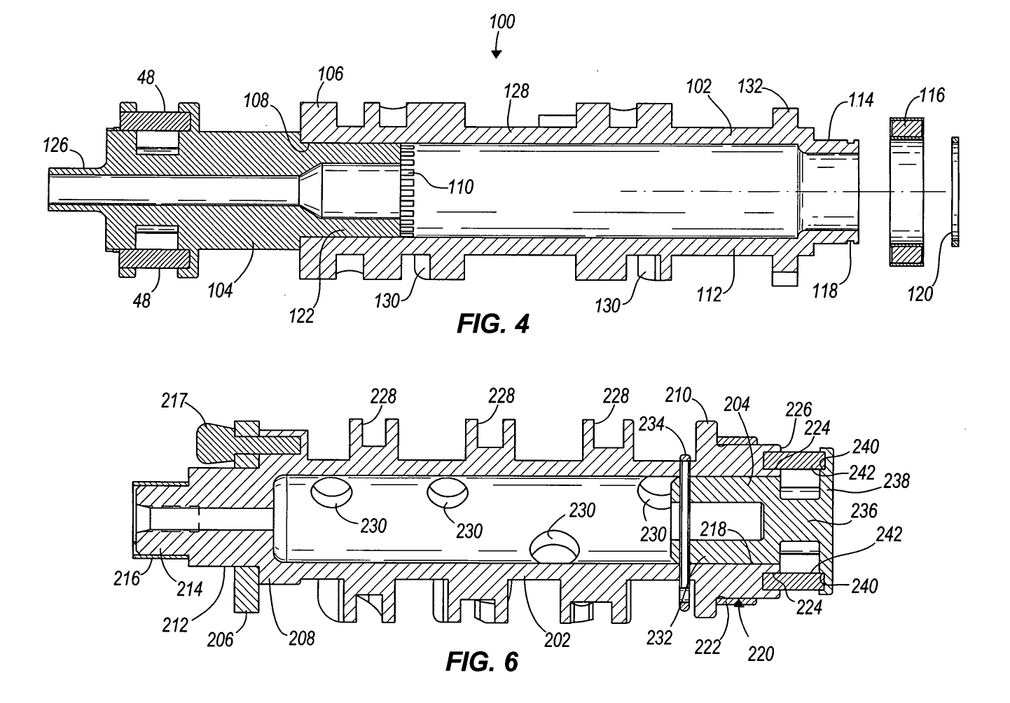

FIGS. 3 and 4 illustrate a shifter cam 100 that is an alternative embodiment of the invention. The shifter cam 100 includes a drum 102 comprised of the second material, and an end cap 104 comprised of the first material. The drum 102 is generally cylindrical and includes a first end 106 defining a bore 108 including an internally splined surface 110. The drum 102 also includes a second end 112 defining an outer cylindrical surface 114 that is received by a bushing or bearing 116 which rotatably supports the second end 112. A circumferential groove 118 defined by the second end 112 receives a retaining ring 120 to axially position the bearing with respect to the cylindrical surface 114.

The end cap 104 includes a generally cylindrical projection 122 that is received by the bore 108 and, in the illustrated construction, is press-fit into the bore 108. During assembly, as the cylindrical projection 122 is press-fit into the bore 108, the splines, which are formed from the harder second material, deform the softer material of the cylindrical projection 122, thereby forming grooves in the cylindrical projection 122. Engagement of the splines within the grooves improves the torque-carrying capacity of the interface between the end cap 104 and the drum 102.

The end cap 104 also includes an end portion 124 that is configured similarly to the second end 38 of the second drum portion 14 discussed above. The end portion 124 supports shift pins 48 in the same manner as the second end 38 of the second drum portion 14. The shift pins 48 are engaged by a shifter pawl (not shown) during operation to rotate the shifter cam 100, thereby changing the gear ratios of an associated transmission in a known manner. The end portion 124 also includes a cylindrical extension 126 that is received by a support member (not shown) such as a bearing or bushing for rotational support of the end cap 104.

The drum 102 includes a central portion 128 that is machined to define a plurality of shift tracks 130. In the illustrated construction there are two shift tracks 130, it should be appreciated however that more or fewer shift tracks 130 can be formed in the central portion 128 to configure the shifter cam 100 for use with a particular transmission.

In addition to the central portion, the drum 102 also includes an integrally formed detent plate 132. The detent plate 132 defines a plurality of radially extending projections 134 and a plurality of concave recesses 136 between the projections 134. One of the projections 134 includes an end portion that defines a radially-outwardly facing surface 138. The detent plate 132 cooperates with a detent arm (not shown) that is biased into engagement with the detent plate 132. Rotation of the shifter cam 100 (e.g. by engagement of the shifter pawl with the shift pins 48) causes the detent arm to cam into and out of engagement with the concave recesses 136, thereby providing rotation of the shifter cam 100 between predetermined angular positions. The shift tracks 130 are formed in such a manner that each angular position of the shifter cam 100 corresponds to a specific gear ratio of the transmission. The radially-outwardly facing surface 138 is provided such that the transmission can be placed in a neutral position in which none of the gears are drivingly engaged. Generally, the neutral position is provided between concave recesses 136 that correspond with first and second gears. The detent plate 34 discussed above is configured and operates substantially identically to the detent plate 132, the primary difference being that the detent plate 34 is press fit onto the first drum portion 12 whereas the detent plate 132 is integrally formed with the drum 102.

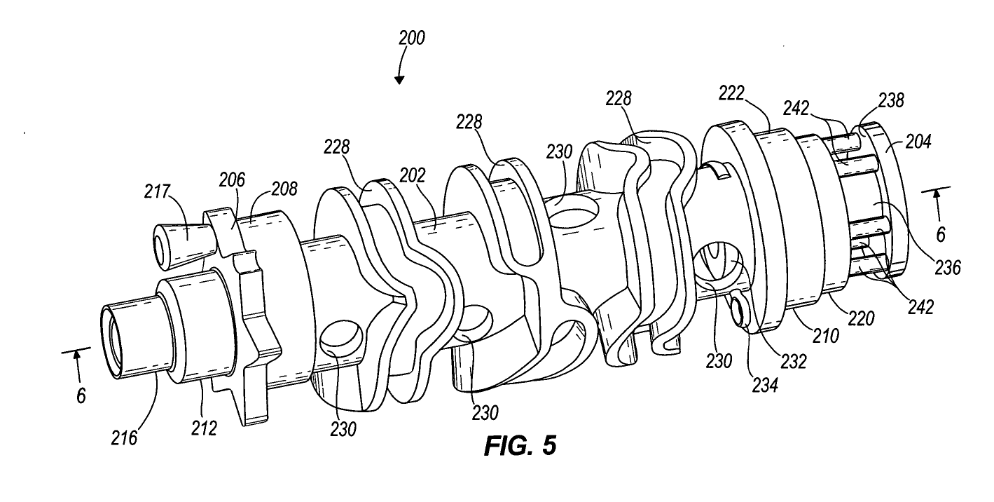

FIGS. 5 and 6 illustrate a shifter drum 200 that is yet another alternative embodiment of the invention. The shifter drum 200 includes a drum 202 comprised of the second material, an end cap 204 comprised of the first material, and a detent plate 206 comprised of the second material. The drum 202 generally defines a hollow cylinder including a first end 208 and a second end 210. The first end 208 includes an outer cylindrical surface 212 that engages the detent plate 206, and a cylindrical projection 214 that is received by a bushing 216 for support of the first end 208. A peg 217, similar to the peg 35, provides angular alignment of the detent plate 206. The pegs 35, 217 may also be used to trip a neutral sensor (not shown) that provides a visible indication to an operator that the transmission has been placed in neutral.

The second end 210 defines a bore 218 including an internally splined surface (not shown) that is similar to the internally splined surface 110 discussed above. The second end 210 also includes an outer cylindrical surface 220 that is received by a bushing 222 for support of the second end 210. A plurality of angularly spaced apart blind bores 224 are defined in an end surface 226 of the second end 210 and open axially away from the drum 202. A plurality of shift tracks 228 are formed in the drum 202 and operate in the same manner as the shift tracks 54, 130 discussed above. Material between the shift tracks 228 is also machined away to minimize the total amount of material in the drum 202. Apertures 230 are also machined into the drum 202 to further reduce the amount of material making up the drum 202.

The end cap 204 includes a cylindrical projection 232 that is received by the bore 218. Specifically, the cylindrical projection 232 is press fit into the bore 218. Like the cylindrical projection 122 and bore 108 of the shifter cam 100 discussed above, the splines of the bore 218 deform the softer material of the cylindrical projection 232 in a manner that improves the torque-carrying capacity of the interface between the end cap 204 and the drum 202. A pin 234 is provided to further couple the end cap 204 and the drum 202 to one another. The pin 234 extends through both the drum 202 and the end cap 204 inboard of the second end 210.

The end cap 204 further includes a reduced diameter portion 236 and a flange portion 238. The flange portion 238 defines a plurality of angularly spaced apart blind bores 240 that correspond to the blind bores 224 defined in the end surface 226 of the drum 202. The blind bores 240 open toward, and are substantially aligned with the blind bores 224 when the end cap 204 is assembled with the drum 202. As the end cap 204 is pressed into the drum 202, the blind bores 224, 240 cooperate to capture and support the shift pins 242. The shift pins 242 operate in the same manner as the shift pins 48 discussed above to impart rotation to the shifter cam 200.

The embodiments discussed above and illustrated in FIGS. 1-6 each utilize a composite construction that allows the mass of the shifter cam to be reduced by utilizing light-weight materials (e.g., the first material), such as aluminum, aluminum alloys, carbon fiber composites, other lightweight metals and/or polymers, in areas that experience reduced amounts of wear during use. Areas that experience higher amounts of wear, such as the shift tracks and the detent plates, are constructed of more durable materials (e.g., the second material), such as steel, which are generally heavier than the lightweight materials discussed above.

The terms “first” and “second” are used in the specification and claims to distinguish between two different types of material and each of these terms by itself should not be limited to any specific type of material or material property. For example, the first material in the specification describes a light-weight material while the first material in some of the claims instead recites the more durable material.

Although three specific embodiments have been illustrated and described, it should be appreciated that certain aspects of each embodiment can be combined or interchanged with certain aspects of other embodiments. For example, the end cap configuration of the shifter cam 200 could be interchanged with the end cap configurations of the shifter cams 10, 100. Furthermore, the press-fit including an internally splined surface that is utilized between the end caps and drums of the shifter cams 100 and 200 could be implemented between the first and second drum portions of the shifter cam 10.

Various features of the invention are set forth in the following claims.

We claim:

1. A shifter cam for a sequential transmission, the shifter cam comprising:
a generally cylindrical drum that defines an axis, the drum having a first end, a second end, and an outer surface that defines a plurality of shifter tracks, the drum comprised of a first material; and
an end cap coupled to the first end of the drum and having a generally cylindrical portion that is substantially axially aligned with the axis, the end cap comprised of a second material having a lower density than the first material.

2. The shifter cam of claim 1, further comprising a plurality of circumferentially spaced shift pins extending substantially parallel to the axis, the shift pins at least partially supported by the end cap and engageable to rotate the end cap and drum about the axis.

3. The shifter cam of claim 2, wherein the end cap defines a first plurality of cylindrical recesses spaced about the axis, and the drum defines a second plurality of cylindrical recesses spaced about the axis, the first and second pluralities of recesses facing one another, wherein each of the first plurality of cylindrical recesses receives a first end of a corresponding shift pin, and each of the second plurality of cylindrical recesses receives a second end of the corresponding shift pin.

4. The shifter cam of claim 2, wherein the end cap defines a first flange adjacent the shifter drum, the first flange defining a plurality of cylindrical recesses spaced about the axis and opening away from the shifter drum, the end cap further defining a second flange axially spaced from the first flange and defining a plurality of apertures, each aperture substantially aligned with a corresponding cylindrical recess, and wherein the shift pins are inserted into aligned pairs of the apertures and cylindrical recesses.

5. The shifter cam of claim 1, wherein the end cap is press fit into a bore defined by the drum.

6. The shifter cam of claim 5, wherein the end cap defines a generally cylindrical projection that is received by the bore, and wherein the bore defines an internally splined portion that engages the cylindrical projection.

7. The shifter cam of claim 1, wherein the first material has an increased surface hardness with respect to the second material.

8. The shifter cam of claim 1, further comprising a detent plate coupled to one of the first and second ends, the detent plate including a plurality of radially extending projections, and a plurality of concave recesses between the projections, one of the projections defining a radially outwardly facing concave surface, wherein the detent plate is comprised of the first material.

9. A shifter cam assembly for a motorcycle transmission, the assembly comprising:
a generally cylindrical drum defining an axis, the drum including a first end, a second end, and a track portion defining a plurality of shifter tracks between the first and second ends, at least one of the shifter tracks formed at least partially of a first material; and
a flange adjacent the first end, the flange comprised of a second material having a lower density than the first material.

10. The shifter cam assembly of claim 9, wherein the flange defines a plurality of bores extending substantially parallel to and angularly spaced around the axis, and wherein the shifter cam assembly further comprises a plurality of shift pins, each shift pin received by a corresponding bore and engageable for rotation of the shifter cam assembly about the axis.

11. The shifter cam assembly of claim 9, further comprising a detent plate coupled to one of the first and second ends, the detent plate including a plurality of radially extending projections, and a plurality of concave recesses between the projections, one of the projections defining a radially outwardly facing concave surface, wherein the detent plate is comprised of the first material.

12. The shifter cam assembly of claim 9, wherein the drum includes a central portion comprised of the second material, and a sleeve portion coupled to the central portion, defining the at least one shifter track, and comprised of the first material.

13. The shifter cam assembly of claim 12, wherein the plurality of shifter tracks includes three axially spaced apart shifter tracks that extend circumferentially around the drum, and wherein the sleeve portion defines a central one of the shifter tracks.

14. The shifter cam assembly of claim 12, wherein the central portion includes a first portion defining the first end, and a second portion coupled to the first portion and defining the second end.

15. The shifter cam assembly of claim 14, wherein one of the first and second portions receives the other of the first and second portions.

16. The shifter cam assembly of claim 9, wherein the flange is integrally formed with the drum.

17. A method for making a shifter cam for a sequential transmission, the method comprising:
providing a first drum portion comprised of a first material and having a first end and a second end;
providing a second drum portion comprised of the first material and having a first end and a second end;
providing a sleeve portion comprised of a second material having an increased hardness with respect to the first material;
positioning the sleeve portion to overlie an outer surface of the first end of the first drum portion;
coupling the first end of the second drum portion to the first end of the first drum portion to define a drum assembly comprising the first and second drum portions and the sleeve portion; and
machining shifter tracks into the sleeve portion, at least one of the shifter tracks defined by the sleeve portion.

18. The method of claim 17, wherein positioning the sleeve portion includes press-fitting the sleeve portion over the first end of the first drum portion.

19. The method of claim 17, wherein positioning the sleeve portion includes extending at least one pin generally radially through the sleeve portion and into the first drum portion to prevent relative rotation between the sleeve portion and the first drum portion.

20. The method of claim 17, wherein coupling the first end of the second drum portion to the first end of the first drum portion includes inserting the first end of the second drum portion into a bore defined by the first end of the first drum portion.

21. The method of claim 20, wherein inserting the first end of the second drum portion into the bore defined by the first end of the first drum portion includes press-fitting the first end of the second drum portion into the bore.

22. The method of claim 17, further comprising coupling a detent plate to the second end of the first drum portion, the detent plate comprised of the second material.

23. The method of claim 17, further comprising coupling a plurality of axially extending shift pins to the second end of the second drum portion.
